(19) United States
(12) Patent Application Publication
(10) Pub. No.: US 2024/0377672 A1
(43) Pub. Date: Nov. 14, 2024

(54) Display Device and Fixing Structure Set

(71) Applicant: Jet Optoelectronics Co., Ltd., Taipei City (TW)

(72) Inventors: Ming-Te Hung, Taipei City (TW); Wen-Ta Lee, Taipei City (TW); Wei-Kuo Chiu, Taipei City (TW); Ching-Hsing Lin, Taipei City (TW)

(21) Appl. No.: 18/464,642

(22) Filed: Sep. 11, 2023

(30) Foreign Application Priority Data
May 10, 2023 (TW) 112117372

(51) Int. Cl. G02F 1/1333

(52) U.S. Cl. CPC G02F 1/133317

(57) ABSTRACT

A display device and a fixing structure set are provided. The display device includes a middle frame and a display panel. The middle frame has a first surface and a second surface opposite to the first surface. The display panel is fixed on the first surface by using at least one first fixing structure set and a plurality of second fixing structure sets. Wherein, the fixing structure of the first fixing structure set is different from the fixing structure of the second fixing structure set.

### CROSS-REFERENCE TO RELATED APPLICATION

This application claims the priority and benefit of Taiwan Patent Application No. 112117372 filed on May 10, 2023 within TIPO, the disclosure of which is incorporated by reference in its entirety as if fully set forth herein.

### TECHNICAL FIELD

The present invention relates to a display device, and more particularly, to a display device and a fixing structure set to improve display problems of the display device by using a specific assembly scheme.

### BACKGROUND

In the related art, a MURA effect extensively occurs in a screen. Since the cause of the occurrence has a directly proportional relation with uneven force applied to the screen, removing the residual stress of the screen is an important issue in designing the mechanism of a display device.

Recently, lots of electronic devices are composed of different assembly components. For example, in regard to a display device using various technological products, a display panel is assembled on a structurally reinforced middle frame during a production process, and thereafter, a front cover plate and a rear cover plate are assembled to the middle frame. Since the above-listed components are assembled to the middle frame, a multi-level fixation may cause severe stress deformation, and the deformation of the middle frame may exert an effect of generating the MURA effect on a liquid crystal display module (LCD module, LCM) of a screen display device.

In conclusion, the inventor of the present invention has considered and designed a display device and a fixing structure set, so as to improve the deficiencies of the related art and increase the industrial applicability.

### SUMMARY

An object of the present invention is to provide a display device and a fixing structure set in order to solve the above-described conventional problems.

In order to achieve the above object, the present invention provides a display device including a middle frame and a display panel. The middle frame has a first surface and a second surface opposite to each other. The display panel is fixed to the first surface by using at least one first fixing structure set and a plurality of second fixing structure sets, a portion of the at least one first fixing structure set is disposed on the middle frame, another portion of the at least one first fixing structure set is disposed on the display panel, a portion of the second fixing structure sets is disposed on the middle frame, and another portion of the second fixing structure sets is disposed on the display panel. The first fixing structure set has a fixing configuration different from a fixing configuration of the second fixing structure set.

Preferably, the first fixing structure set includes a stud, a through-hole, a buffer member and a fixing piece, and the stud is disposed on the display panel and has a base section. The through-hole is formed in the middle frame; the buffer member surrounds the base section and is sleeved onto the stud; and the fixing piece is fastened to the stud by passing through the through-hole from one side of the middle frame opposite to the display panel.

Preferably, when the display panel is disposed on the first surface of the middle frame, an end surface of the base section comes into contact with an end surface of the fixing piece, a first gap is provided between the buffer member and the middle frame, and a second gap is provided between a head of the fixing piece and the middle frame.

Preferably, a third gap is provided between the wall surface of the through-hole and the fixing piece.

Preferably, the buffer member is a spring; and when the display panel is disposed on the first surface of the middle frame and when the fixing piece is fully fixed into the stud, distances are defined between the end surface of the base section and the end surface of the fixing piece and between the head of the fixing piece and the middle frame, and the buffer member is in a free length state in which no force is applied.

Preferably, a distance is defined between a wall surface of the through-hole and the fixing piece.

Preferably, the number of the second fixing structure sets is at least three, and the at least three second fixing structure sets and the at least one first fixing structure set are disposed along four vertices of a rectangle.

In order to achieve the above object, the present invention further provides a fixing structure set for fixing the display panel to the middle frame. The fixing structure set includes a stud, a through-hole, a buffer member and a fixing piece. The stud is disposed on the display panel and has a base section. The through-hole is disposed in the middle frame. The buffer member surrounds the base section and is sleeved onto the stud. The fixing piece is fastened to the stud by passing through the through-hole from one side of the middle frame opposite to the display panel. When the display panel is disposed on one side of the middle frame, a distance is defined between a wall surface of the through-hole and the fixing piece.

Preferably, when the display panel is disposed on one side of the middle frame, an end surface of the base section comes into contact with an end surface of the fixing piece, and a gap is provided between the buffer member and the middle frame.

Preferably, the buffer member is a spring; and when the display panel is disposed on one side of the middle frame and when the fixing piece is fully fixed into the stud, distances are defined between the end surface of the base section and the end surface of the fixing piece and between the head of the fixing piece and the middle frame, and the buffer member is in or approximately in an inelastically tensile state or an inelastically compressed state.

Hereinafter, the technical features of the present invention will be described in detail with accompanying drawings according to specific embodiments in order for those skilled in the art to easily understand the objects, technical features, and effects of the present invention.

### BRIEF DESCRIPTION OF THE DRAWING

Hereinafter, embodiments of the present invention will be briefly described with reference to the necessary accompanying drawings in order to more clearly describe the technical solutions of the embodiments of the present invention. It is apparent that the drawings shown below are merely for illustrating some embodiments of the present invention, and those skilled in the art may obtain other drawings based on the above drawings.

FIG. 1 is a schematic diagram showing the structure of a display device of the present invention.

FIG. 2 is a schematic diagram showing the configuration of a first fixing structure set of the first embodiment of the display device of the present invention.

FIG. 3 is a schematic diagram showing the configuration of a first fixing structure set of the second embodiment of the display device of the present invention.

### DETAILED DESCRIPTION

Advantages, features and technical solutions to be achieved according to the present invention will be more easily understood by describing in more detail the accompanying drawings and the embodiments as reference examples. Further, the present invention may be implemented in various forms and will not be construed as being limited only to the embodiments described herein. Whereas, for those skilled in the art, the embodiments will be provided with a more thorough understanding of the disclosure and the scope of the present invention will be fully delivered. Further, the present invention will be subject to the following claims.

It is noted that terms such as “first” and “second” may be used herein to describe various components, members, regions, sections, layers, and/or sites. However, the components, members, regions, sections, layers and/or sites are not limited thereto. The above terms are only used to distinguish one component, member, region, section, layer and/or site from another component, member, region, section, layer and/or site.

Unless otherwise defined, all terms (including technical and scientific terms) used herein may have the same meanings as commonly understood by those skilled in the art. It is also noted that the terms such as commonly used dictionary definitions will be interpreted to have definitions consistent with meanings in the context of the relevant art and the present invention, and will not to be interpreted in an idealized or overly formal sense unless explicitly defined herein.

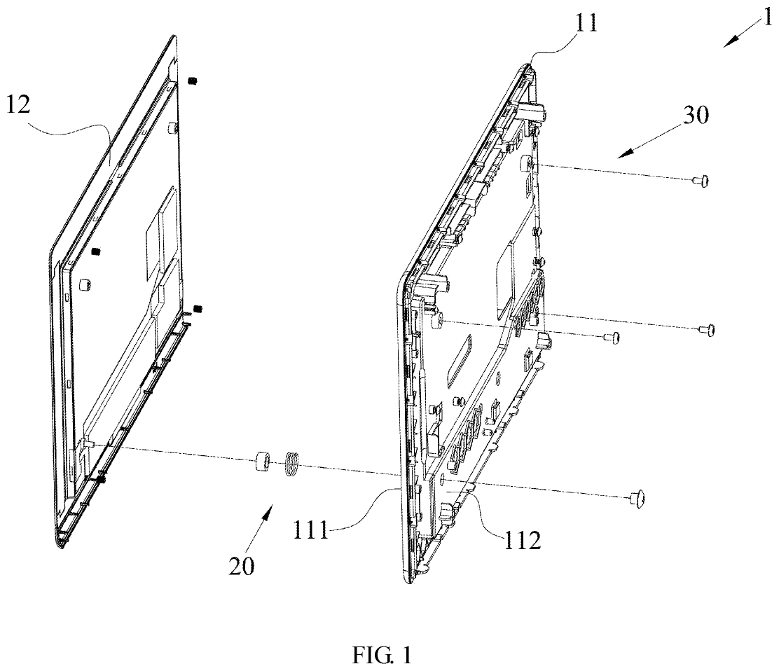

FIG. 1 is a schematic diagram showing the structure of a display device of the present invention. As shown in the drawings, the display device 1 of the present invention includes a middle frame 11 and a display panel 12.

The middle frame 11 may have the nature of not easy to be deformed, i.e., a limited amount of deformation. The middle frame 11 has a first surface 111 and a second surface 112 opposite to the first surface 111. The display panel 12 refers to a display panel known or generally used by those skilled in the art and is fixed to the first surface using at least one first fixing structure set 20 and a plurality of second fixing structure sets 30, in which a portion of the at least one first fixing structure set 20 is disposed on the middle frame 11, another portion of the at least one first fixing structure set 20 is disposed on the display panel 12, a portion of the second fixing structure sets 30 is disposed on the middle frame 11, and another portion of the second fixing structure sets 30 is disposed on the display panel 12. The second fixing structure set 30 or engagement structure may be technical means known to or generally used by those skilled in the art. For example, the second fixing structure set 30 may include a pillar disposed on the display panel 12 and formed therein with a screw hole, and a hole disposed in the middle frame 11 and formed therein with a through-hole. And accordingly, a screw may be fastened to the screw hole through the through-hole, so that the display panel 12 may be fixed to the middle frame 11. In addition, in the above manner, it is preferable that the pillar may abut against a bottom surface formed inside of the hole.

Particularly, a fixing structure of the first fixing structure set 20 is different from a fixing structure of the second fixed set structure 30. When the display panel 12 is fixed to the first surface 111, the display panel 12 does not get stressed onto the first fixing structure set 20, or the display panel 12 gets less stressed onto the second fixing structure set 30 than the first fixing structure set 20. Preferably, the number of the second fixing structure sets may be at least three. The at least three second fixing structure sets 30 and the at least one first fixing structure set 20 are disposed along four vertices of a rectangular. The display device 1 of the present invention uses a fixing scheme according to technical means known to or generally used by those skilled in the art in order to be fixed to the three points between the display panel 12 and the middle frame 11. In addition, the three fixed points may form a plane, so as to ensure that the display device 1 of the present invention is flattened and no residual internal stress is present. In addition, the second fixing structure set 30 having a predetermined structural arrangement is additionally used, and accordingly, the display panel 12 is fixedly attached to the middle frame 11 while a gap is maintained. Thus, under the condition that the display panel 12 is firmly fixed to the middle frame 11, the display panel 12 is prevented from being stressed at the fixing points of the second fixing structure set 30, so as to maximally ensure a state in which no internal stress exists in the display panel 12. Accordingly, the display device 1 of the present invention can prevent the Mura effect from occurring in a liquid crystal display module (LCD module, LCM) of a screen display device due to deformation of the middle frame 11.

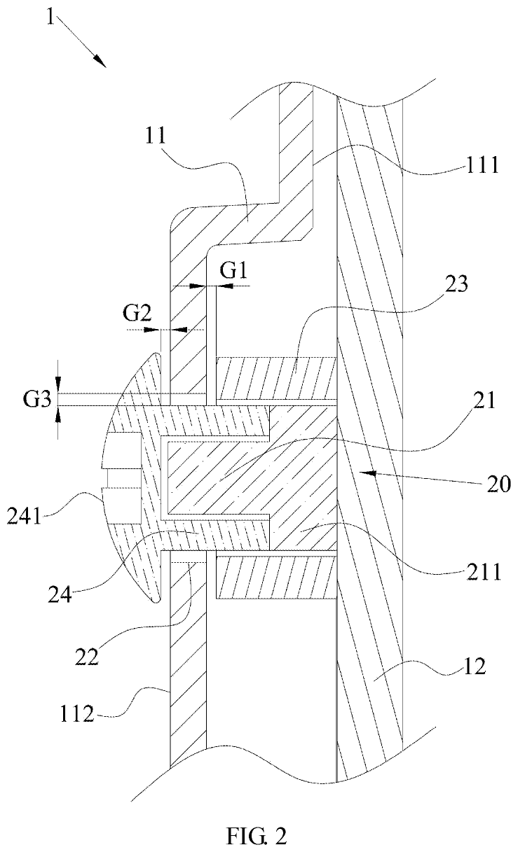

Referring to FIG. 2 together with FIG. 1, FIG. 2 is a schematic diagram showing the configuration of a first fixing structure set of the first embodiment of the display device of the present invention.

As shown in the drawings, the first fixing structure set 20 includes a stud 21, a through-hole 22, a buffer member 23 and a fixing piece 24. The stud 21 is configured to be disposed on the display panel 12 and has a base section 211. The through-hole 22 is disposed in the middle frame 11 to pass through the first surface 111 and the second surface 112 of the middle frame 11. The buffer member 23 may be formed of an elastic buffer material such as rubber or may be a part such as a spring. In the embodiment, the buffer member 23 is formed as, for example, a pipe or a hollow cylinder made of an elastic buffer material such as rubber. However, the present invention is not limited thereto. The buffer member 23 may be disposed to surround the base section 211 and sleeved onto the stud 21. The fixing piece 24 may be a screw part having a female thread so as to be fastened to the stud 21 from one side of the middle frame 11 opposite to the display panel 12 through the through-hole 22.

Particularly, when the display panel 12 is disposed on the first surface 111 of the middle frame 11, an end surface of the base section 211 comes into contact with an end surface of the fixing piece 24, a first gap G1 is provided between the buffer member 23 and the middle frame 11, and a second gap G2 is provided between a head 241 of the fixing piece 24 and the middle frame 11. In addition, preferably, a third gap G3 is provided between a wall surface of the through-hole 22 and the fixing piece 24.

In the embodiment, by the configuration of the first gap G1, the second gap G2 and the third gap G3, the display panel 12 may be prevented from being stressed at the fixing points of the first fixing structure set 20 so as to maximally ensure a state in which no internal stress exists in the display panel 12 itself.

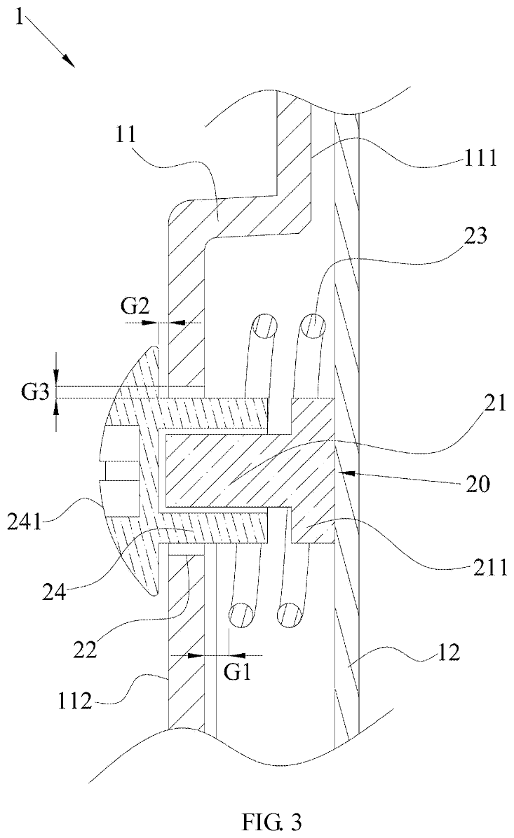

Referring to FIG. 3 together with FIG. 1, FIG. 3 is a schematic diagram showing the configuration of a first fixing structure set of the second embodiment of the display device of the present invention.

As shown in the drawings, the first fixing structure set 20 includes a stud 21, a through-hole 22, a buffer member 23 and a fixing piece 24. The stud 21 is configured to be disposed on the display panel 12 and has a base section 211. The through-hole 22 is disposed in the middle frame 11 to pass through the first surface 111 and the second surface 112 of the middle frame 11. The buffer member 23 may be formed of an elastic buffer material such as rubber or may be a part such as a spring. In the embodiment, the buffer member 23 is exemplified as a spring. However, the present invention is not limited thereto. The buffer member 23 may surround the base section 211 and sleeved onto the stud 21. The fixing piece 24 may be a screw part having a female thread so as to be fastened to the stud 21 from one side of the middle frame 11 opposite to the display panel 12 through the through-hole 22.

Particularly, when the display panel 12 is disposed on the first surface 111 of the middle frame 11 and when the fixing piece 24 is secured into the bottom of the stud 21 (for example, upon tightened), distances are defined between the end surface of the base section 211 and the end surface of the fixing piece 24 and between the head 241 of the fixing piece 24 and the middle frame 11. The buffer member is in or approximately in an inelastically compressed state. A distance is defined between the wall surface of the through-hole 22 and the fixing piece 24.

Particularly, the buffer member 23 being in or approximately in the inelastically compressed state refers to a state in which the buffer member 23 does not get stressed or gets slightly stressed due to fastening force. In addition, the buffer member is in or approximately in an inelastically compressed state, and for example, the buffer member 23 may have a free length the same as the distance between the display panel 12 and the middle frame 11. Alternatively, the free length of the buffer member 23 may be slightly smaller or slightly larger than the distance between the display panel 12 and the middle frame 11.

In the embodiment, the buffer member 23 such as a spring is provided between the display panel 12 and the middle frame 11, and the buffer member is in or approximately in an inelastically compressed state so as to ensure that the display panel 12 has no internal stress. In addition, when the display device 1 receives external force, the buffer member 23 may properly buffer and deform. In addition, even when the MURA effect occurs, the tightening of the fixing piece 24 may be adjusted, and accordingly, the residual stress in the screen itself is eliminated.

The fixing structure set according to the present invention is the same as or similar to the first fixing structure set of the display device of the present invention. Accordingly, details of the fixing structure set of the present invention have already been described in the display device of the present invention. Thus, identical or similar description will not be repeated herein.

The above description is only for illustrative purpose and the present invention is not limited thereto. All modifications and changes within the scope without departing from the spirit of the present invention are included in the claims appended hereto.

What is claimed is:

1. A display device comprising:
a middle frame having a first surface and a second surface opposite to the first surface; and
a display panel configured to be fixed to the first surface using at least one first fixing structure set and a plurality of second fixing structure sets, in which a portion of the at least one first fixing structure set is disposed on the middle frame, another portion of the at least one first fixing structure set is disposed on the display panel, a portion of the second fixing structure sets is disposed on the middle frame, and another portion of the second fixing structure sets is disposed on the display panel, wherein
the first fixing structure set has a fixing configuration different from a fixing configuration of the second fixing structure set.

2. The display device of claim 1, wherein the first fixing structure set includes a stud, a through-hole, a buffer member and a fixing piece,
the stud is disposed on the display panel and has a base section,
the through-hole is disposed in the middle frame,
the buffer member surrounds the base section and is sleeved onto the stud, and
the fixing piece is configured to be fastened to the stud by passing through the through-hole from one side of the middle frame opposite to the display panel.

3. The display device of claim 2, wherein, when the display panel is disposed on the first surface of the middle frame, an end surface of the base section comes into contact with an end surface of the fixing piece, a first gap is provided between the buffer member and the middle frame, and a second gap is provided between a head of the fixing piece and the middle frame.

4. The display device of claim 3, wherein a third gap is provided between a wall surface of the through-hole and the fixing piece.

5. The display device of claim 2, wherein the buffer member includes a spring, and when the display panel is disposed on the first surface of the middle frame and when the fixing piece is fully fixed into the stud, distances are defined between the end surface of the base section and the end surface of the fixing piece and between the head of the fixing piece and the middle frame, and the buffer member is in a free length state in which no force is applied.

6. The display device of claim 5, wherein a distance is defined between the wall surface of the through-hole and the fixing piece.

7. The display device of claim 1, wherein a number of the plurality of second fixing structure sets is at least three, and the at least three second fixing structure sets and the at least one first fixing structure set are disposed along four vertices of a rectangle.

8. A fixing structure set for fixing a display panel to a middle frame, the fixed structure set comprising:
a stud configured to be disposed on the display panel and having a base section;
a through-hole configured to be disposed in the middle frame;
a buffer member configured to surround the base section and to be sleeved onto the stud; and
a fixing piece configured to be fastened to the stud from one side of the middle frame opposite to the display panel through the through-hole, wherein
a distance is defined between a wall surface of the through-hole and the fixing piece when the display panel is disposed on one side of the middle frame.

9. The fixing structure set of claim 8, wherein, when the display panel is disposed on one side of the middle frame, an end surface of the base section comes into contact with an end surface of the fixing piece, and a gap is provided between the buffer member and the middle frame.

10. The fixing structure set of claim 8, wherein the buffer member includes a spring, and when the display panel is disposed on one side of the middle frame and when the fixing piece is fully fixed into the stud, distances are defined between the end surface of the base section and the end surface of the fixing piece and between the head of the fixing piece and the middle frame, and the buffer member is in or approximately in an inelastically compressed state.
